(19) United States
(12) Patent Application Publication
(10) Pub. No.: US 2020/0207577 A1
(43) Pub. Date: Jul. 2, 2020

(54) SYSTEM AND METHOD FOR ASSIGNING ELEVATOR SERVICE BASED ON A DESIRED LOCATION OF A PLURALITY OF PASSENGERS

(71) Applicant: OTIS ELEVATOR COMPANY, Farmington, CT (US)

(72) Inventors: Guru Charan Kottur, Hyderabad (IN); Bhabani Sankar Nanda, Hyderabad (IN); Aditya Swami, Hyderabad (IN)

(21) Appl. No.: 16/722,991

(22) Filed: Dec. 20, 2019

(30) Foreign Application Priority Data
Dec. 28, 2018 (IN) 201811049532

(51) Int. Cl. B66B 1/46; B66B 5/00; B66B 1/24; H04L 12/40

(52) U.S. Cl. CPC B66B 1/468; B66B 5/0012; B66B 1/2408; H04L 2012/40215; B66B 2201/4615; B66B 2201/4638; H04L 12/40

(57) ABSTRACT

Disclosed is an elevator system including a controller configured for rendering a plurality of determinations and executing one or more communications, including a first determination that captured video on a first floor indicates a first passenger is at waiting for elevator service, a second determination that the first passenger is associated with a first room on a second floor or a first event on the second floor, and a first communication to instruct a first elevator car to transport the first passenger from the first floor to the second floor.

### CROSS-REFERENCE TO RELATED APPLICATIONS

This application claims the benefit of Indian Patent Application No. 201811049532 filed Dec. 28, 2018 the disclosure of which is incorporated herein by reference in its entirety.

### BACKGROUND

The embodiments herein relate to elevator systems and more specifically to a system and method for assigning elevator service based on a desired location of a plurality of passengers.

It may be a challenge to predict one more destination floors for one or more passengers in a passenger group at a lobby. A lack of strategic positioning of elevator cars may create delays in elevator transportation.

### BRIEF SUMMARY

Disclosed is an elevator system comprising a controller configured for rendering a plurality of determinations and executing one or more communications, including a first determination that captured video on a first floor indicates a first passenger is at waiting for elevator service, a second determination that the first passenger is associated with a first room on a second floor or a first event on the second floor, and a first communication to instruct a first elevator car to transport the first passenger from the first floor to the second floor.

In addition to one or more of the above disclosed features or as an alternate the controller is configured for executing a second communication including instructing a first mobile device associated with the first passenger to inform the first passenger that the first elevator car is assigned to transport the first passenger from the first floor to the second floor.

In addition to one or more of the above disclosed features or as an alternate the controller is configured for rendering a third determination that a first plurality of passengers is waiting on the first floor, the first plurality of passengers including the first passenger, rendering a fourth determination that the first plurality of passengers is associated with the first room or first event on the second floor, and executing a third communication to instruct the first elevator car to transport the first plurality of passengers from the first floor to the second floor.

In addition to one or more of the above disclosed features or as an alternate the controller is configured for rendering fourth communication that includes instructing a first plurality of mobile devices inform the first plurality of passengers that the first elevator car is providing transportation to the second floor.

In addition to one or more of the above disclosed features or as an alternate the controller is configured for rendering a fifth determination that a second plurality of passengers is waiting on the first floor, rendering a sixth determination that the second plurality of passengers is associated with a second room or second event on a third floor, executing a fifth communication to instruct a second elevator to transport the second plurality of passengers from the first floor to the second floor.

In addition to one or more of the above disclosed features or as an alternate the controller is configured for executing a sixth communication that includes instructing a second plurality of mobile devices to inform the second plurality of passengers that the second elevator is providing transportation to the third floor.

In addition to one or more of the above disclosed features or as an alternate the controller is configured for transmitting captured data to a building management system (BMS); and receiving from the BMS instructions to provide elevator service to the second floor and the third floor respectively for the first plurality of passengers and the second plurality of passengers.

In addition to one or more of the above disclosed features or as an alternate the controller is configured for communicating with the building management system over a wireless network executing local area network (LAN) protocols.

In addition to one or more of the above disclosed features or as an alternate the controller is configured for communicating with the plurality of mobile devices over a wireless network executing personal area network (PAN) protocols.

In addition to one or more of the above disclosed features or as an alternate the controller is configured for communicating with the plurality of elevators over a CAN network.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates implements of an elevator system that may employ various embodiments of the present disclosure; and

FIGS. 3-6 illustrate various process steps that may be employed by embodiments of the present disclosure.

### DETAILED DESCRIPTION

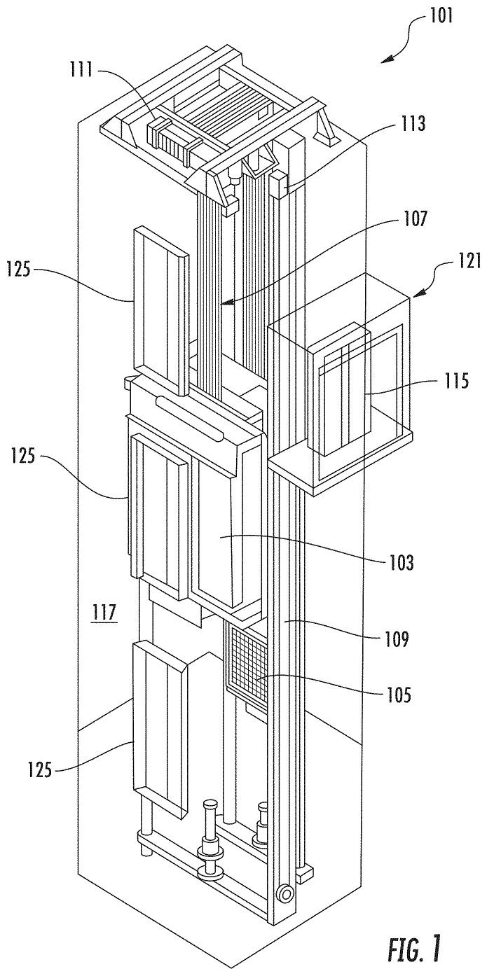

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

The following figures illustrate additional technical features associated with one or more disclosed embodiments. Features disclosed in the following figures having nomenclature similar to features disclosed in FIG. 1 may be similarly construed though being positively reintroduced with numerical identifiers that may differ from those in FIG. 1.

Further, process steps disclosed herein may be sequentially numbered by order of introduction to facilitate discussion of one or more disclosed embodiments. Thus, a set of steps having an initial range may include subsequently introduced steps having numbers that are sequentially outside the initial range. Such numbering is not intended to identify a specific sequence of performing such steps, a specific requirement to perform such steps, or to exclude performing additional steps, unless expressly indicated.

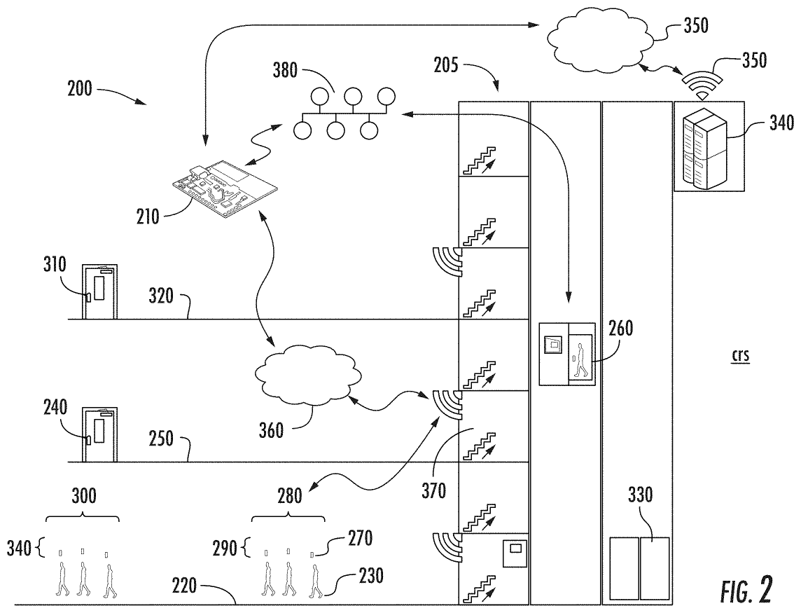

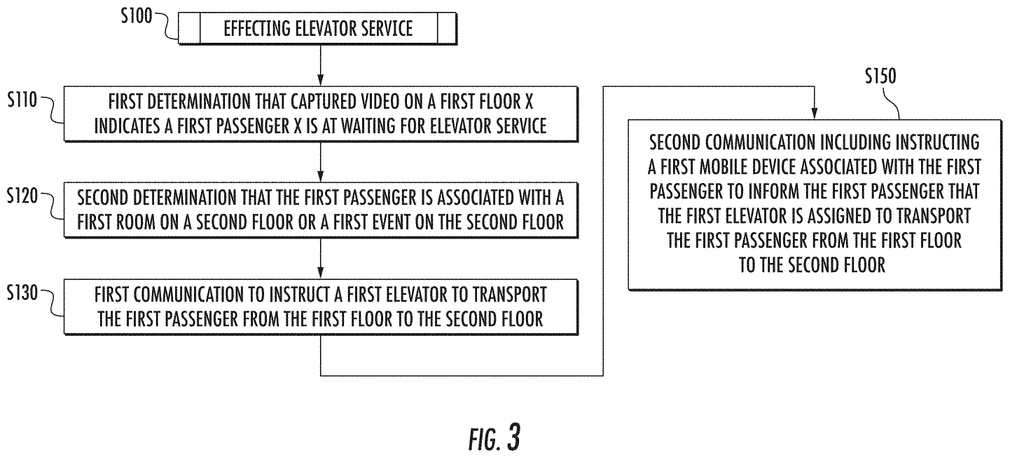

Turning to FIGS. 2 and 3, disclosed is an elevator system 200 in a building 205. The elevator system 200 may include a controller 210 that configured for executing step S100 of effecting elevator service, which includes rendering a plurality of determinations and executing one or more communications for providing elevator service. At step S110 the controller 210 renders a first determination that video capture on a first floor 220 indicates a first passenger 230 is at waiting for elevator service on the first floor 220. At step S120 the controller 210 renders a second determination that the first passenger 230 is associated with a first room 240 on a second floor 250 or a first event on the second floor 250. At step S130 the controller 210 executes a first communication to instruct a first elevator car 260 to transport the first passenger 230 from the first floor 220 to the second floor 250. At step S150 the controller 210 may be configured for executing a second communication of instructing a first mobile device 270 associated with the first passenger 230 to inform the first passenger 230 that the first elevator car 260 is assigned to transport the first passenger 230 from the first floor 220 to the second floor 250.

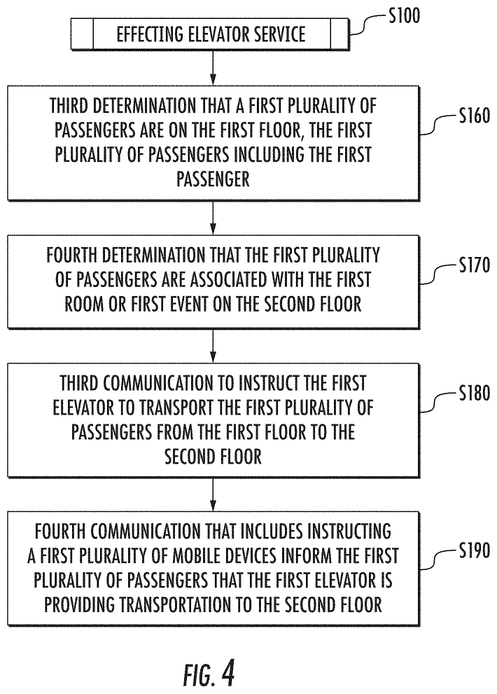

Turning to FIG. 4, in one embodiment, when executing step S100, the controller 210 may also be configured for performing step S160 of rendering a third determination that a first plurality of passengers 280 are waiting on the first floor 220. The first plurality of passengers 280 may include the first passenger 230. At step S90 the controller 210 may render a fourth determination that the first plurality of passengers 280 are associated with the first room 240 or first event on the second floor 250. At step S200 the controller 210 may execute a third communication to instruct the first elevator car 260 to transport the first plurality of passengers 280 from the first floor 220 to the second floor 250. At step S190 the controller 210 is configured for executing a fourth communication that includes instructing a first plurality of mobile devices 290 to inform the first plurality of passengers 280 that the first elevator car 260 is providing transportation services from the first floor 220 to the second floor 250. The first plurality of mobile devices 290 includes the first mobile device 270 for the first passenger 230.

Turning to FIG. 5, in one embodiment, when executing step S100, the controller 210 may also be configured for performing step S200 of rendering a fifth determination that a second plurality of passengers 300 is on the first floor 220. At step S210 the controller 210 may render a sixth determination that the second plurality of passengers 300 is associated with a second room 310 or second event on a third floor 320. At step s220 the controller 210 may executing a fifth communication to instruct a second elevator 330 to transport the second plurality of passengers 300 to the third floor 320. At step S230 the controller 210 may execute a sixth communication to instruct a second plurality of mobile devices 340 to inform the second plurality of passengers 300 that the second elevator 330 is providing transportation to the third floor 320.

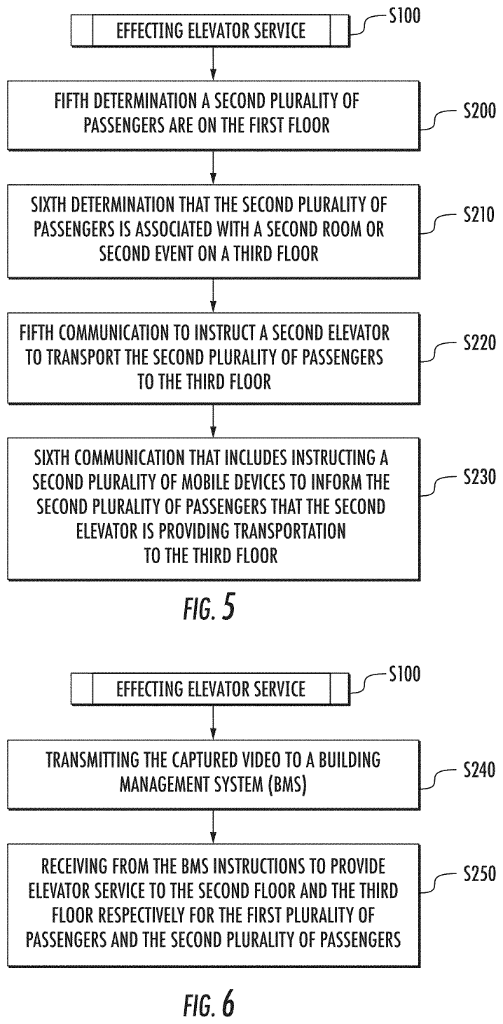

Turning to FIG. 6, in one embodiment, when executing step S100, the controller 210 may also be configured for performing step S240 of transmitting the captured video to a building management system (BMS) 340. From this, the BMS 340 identifies the first plurality of passengers 280 and the second plurality of passengers 300. The BMS 340 further determines that the first plurality of passengers 280 is associated with the first room 240 or first event on the second floor 250, and the second plurality of passengers 300 is associated with the second room 310 or second event on the third floor 320. At step S250 the controller 210 may receive from the BMS instructions to provide elevator service to the second floor and the third floor respectively for the first plurality of passengers 280 and the second plurality of passengers 300.

The controller 210 may be configured for communicating with the BMS 340 over a wireless network 350 executing local area network (LAN) protocols. Further, the controller 210 may be configured for communicating with first plurality of mobile devices 290 and the second plurality of mobile devices 340 over a personal area network (PAN) 360 via a PAN beacon 370. Moreover, the controller 210 may be configured for communicating with the elevator cars 260, 330 over a CAN network 380.

Disclosed above is a system that processes a plurality of data when assigning elevator service to a first passenger on the first floor. The plurality of data includes first data obtained from a video capturing system such as a camera associated with the first floor. In one embodiment the system may communicate the first data with a building management system (BMS) to obtain second data and third data. The second data may include an identity of the first passenger. The third data may include a first destination floor for the first passenger. The destination floor may be a floor having a home office or meeting location for the first passenger. The system may assign a first elevator car to service the first passenger based on the third data. When a plurality of passengers is at the lobby, the system may obtain identity data and/or floor destination data for each of the plurality of passengers. The system may assign one or more elevators to service passengers that are traveling to a same floor.

A benefit of the disclosed embodiments may include dynamically detecting passengers in the elevator lobby and grouping the passengers for elevator assignments. Upon receiving a single elevator call, the system may determine that a plurality of elevators is required to service one or more plurality of passengers seeking one or more destination floors. The embodiments may result in avoiding unnecessary elevator calls when providing elevator service for groups of passengers.

As used herein an elevator controller and/or elevator group controller (EGC) may be a microprocessor based controller that controls many aspects of the elevator operation. A series of sensors, controllers, sequences of operation and real-time calculations or algorithms that balance passenger demand and car availability. Elevator sensors may provide data on car positions, car moving direction, loads, door status, hall calls, car calls, pending up hall and down hall calls, number of runs per car, alarms, etc. The controllers may also have a function enabling the testing the systems without shutdown of the elevator. From collected data, a management system consisting of a workstation and software applications that may create metrics for a group or particular car such as total number of door openings, number of runs per car or call, up and down hall calls, etc. Some performance indicators may be related to passenger wait times and/or elevator car travel times. These metrics may indicate inadequate controls, misconfiguration or even equipment malfunction. Elevator monitoring may be provided as Software as a Service (SaaS). The monitoring may identify malfunctions or abnormal operating parameters and automatically dispatch a technician and/or provide alerts to relevant persons such as building owners. Some systems may provide customer dashboards accessible via a web browser and/or provide owners with information such as performance summaries and maintenance histories. As indicated, the elevator controller may communicate with the one or more elevators over a Controller Area Network (CAN) bus. A CAN is a vehicle bus standard that allow microcontrollers and devices to communicate with each other in applications without a host computer. CAN is a message-based protocol released by the International Organization for Standards (ISO). Downstream communications from the elevator system controller may be over a LAN.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising a controller configured for
rendering a plurality of determinations and executing one or more communications, including
a first determination that captured video on a first floor indicates a first passenger is at waiting for elevator service,
a second determination that the first passenger is associated with a first room on a second floor or a first event on the second floor, and
a first communication to instruct a first elevator car to transport the first passenger from the first floor to the second floor.

2. The system of claim 1, wherein the controller is configured for
executing a second communication including instructing a first mobile device associated with the first passenger to inform the first passenger that the first elevator car is assigned to transport the first passenger from the first floor to the second floor.

3. The system of claim 2, wherein the controller is configured for
rendering a third determination that a first plurality of passengers is waiting on the first floor, the first plurality of passengers including the first passenger,
rendering a fourth determination that the first plurality of passengers is associated with the first room or first event on the second floor, and
executing a third communication to instruct the first elevator car to transport the first plurality of passengers from the first floor to the second floor.

4. The system of claim 3, wherein the controller is configured for
rendering fourth communication that includes instructing a first plurality of mobile devices inform the first plurality of passengers that the first elevator car is providing transportation to the second floor.

5. The system of claim 4, wherein the controller is configured for
rendering a fifth determination that a second plurality of passengers is waiting on the first floor,
rendering a sixth determination that the second plurality of passengers is associated with a second room or second event on a third floor,
executing a fifth communication to instruct a second elevator to transport the second plurality of passengers from the first floor to the second floor.

6. The system of claim 5, wherein when the controller is configured for
executing a sixth communication that includes instructing a second plurality of mobile devices to inform the second plurality of passengers that the second elevator is providing transportation to the third floor.

7. The system of claim 6, wherein the controller is configured for
transmitting captured data to a building management system (BMS); and
receiving from the BMS instructions to provide elevator service to the second floor and the third floor respectively for the first plurality of passengers and the second plurality of passengers.

8. The system of claim 7 wherein the controller is configured for
communicating with the building management system over a wireless network executing local area network (LAN) protocols.

9. The system of claim 8 wherein the controller is configured for
communicating with the plurality of mobile devices over a wireless network executing personal area network (PAN) protocols.

10. The system of claim 9 wherein the controller is configured for communicating with the plurality of elevators over a controller area network (CAN) network.

11. A method of controlling an elevator system with a system controller, the method comprising:
rendering a plurality of determinations and executing one or more communications, including
a first determination that captured video on a first floor indicates a first passenger is at waiting for elevator service,
a second determination that the first passenger is associated with a first room on a second floor or a first event on the second floor, and
a first communication to instruct a first elevator car to transport the first passenger from the first floor to the second floor.

12. The method of claim 11, further comprising
executing a second communication including instructing a first mobile device associated with the first passenger to inform the first passenger that the first elevator car is assigned to transport the first passenger from the first floor to the second floor.

13. The method of claim 12, further comprising
rendering a third determination that a first plurality of passengers is waiting on the first floor, the first plurality of passengers including the first passenger,
rendering a fourth determination that the first plurality of passengers is associated with the first room or first event on the second floor, and
executing a third communication to instruct the first elevator car to transport the first plurality of passengers from the first floor to the second floor.

14. The method of claim 13, further comprising
rendering fourth communication that includes instructing a first plurality of mobile devices inform the first plurality of passengers that the first elevator car is providing transportation to the second floor.

15. The method of claim 14, further comprising
rendering a fifth determination that a second plurality of passengers is waiting on the first floor,
rendering a sixth determination that the second plurality of passengers is associated with a second room or second event on a third floor,
executing a fifth communication to instruct a second elevator to transport the second plurality of passengers from the first floor to the second floor.

16. The method of claim 15, further comprising
executing a sixth communication that includes instructing a second plurality of mobile devices to inform the second plurality of passengers that the second elevator is providing transportation to the third floor.

17. The method of claim 16, further comprising
transmitting captured data to a building management system (BMS); and
receiving from the BMS instructions to provide elevator service to the second floor and the third floor respectively for the first plurality of passengers and the second plurality of passengers.

18. The method of claim 17, further comprising
communicating with the building management system over a wireless network executing local area network (LAN) protocols.

19. The method of claim 18, further comprising
communicating with the plurality of mobile devices over a wireless network executing personal area network (PAN) protocols.

20. The method of claim 19, further comprising communicating with the plurality of elevators over a controller area network (CAN) network.
